(19) United States
(12) Patent Application Publication
(10) Pub. No.: US 2007/0140246 A1
(43) Pub. Date: Jun. 21, 2007

(54) Dynamic quality of service (QoS) provisioning in wireless networks

(76) Inventor: Bala Rajagopalan, Beaverton, OR (US)

Correspondence Address: INTEL CORPORATION;C/O INTELLEVATE, LLC, P.O. BOX 52050, MINNEAPOLIS, MN, 55402, US

(21) Appl. No.: 11/303,709

(22) Filed: Dec. 15, 2005

(51) Int. Cl. H04L 12/56

(52) U.S. Cl. 370/392; 370/401

(57) ABSTRACT

A method, apparatus and/or system for communicating in a wireless network may dynamically create and/or delete a medium access control (MAC) quality of service (QoS) connection in a wireless link between a base station and a mobile station. Each wireless base station in the network may have an integrated session initiation protocol (SIP) proxy and the MAC QoS connection may be triggered by session initiation protocol (SIP) signaling received at the base station. Various other detailed embodiments and variants are also disclosed.

### BACKGROUND OF THE INVENTION.

As more and more types of different services are being made available for devices utilizing wireless networks, it is becoming increasingly important to design a wireless medium's physical layer to effectively handle the requirements of traditionally wired data link layer traffic. Many new generation wireless systems are designed to dynamically create medium access control (MAC) level service flows (or connections) with associated quality of service (QoS) requirements. However, there is an ongoing need to provide suitable mechanisms for Internet Protocol (IP)—based applications to trigger the creation of these MAC connections with the appropriate QoS level on demand.

### BRIEF DESCRIPTION OF THE DRAWING.

Aspects, features and advantages of embodiments of the present invention will become apparent from the following description of the invention in reference to the appended drawing in which like numerals denote like elements and in which:

FIG. 1 is block diagram of an example wireless network according to various embodiments;

FIG. 2 is a sequence diagram showing a process of communicating in a wireless network according to one embodiment;

FIG. 3 is a block diagram showing a process of communicating in a wireless network during handoff according to various embodiments of the present invention; and

FIG. 4 is a block diagram showing an example wireless base station according to various aspects of the present invention.

### DETAILED DESCRIPTION OF THE INVENTION.

While the following detailed description may describe example embodiments of the present invention in relation to broadband wireless networks such as WiMAX (an acronym that stands for Worldwide Interoperability for Microwave Access) or EVDO (Evolution Data Only) networks, the inventive embodiments may be applicable to any type of wireless metropolitan area network (WMAN) where similar advantages may be obtained. Additionally, the inventive embodiments are not limited to WMANs and may relate to, if applicable, wireless local area networks (WLANs), wireless personal area networks (WPANs) and/or wireless wide area networks (WWANs) such a cellular networks and the like. Further, while specific embodiments may be described in reference to wireless networks utilizing Orthogonal Frequency Division Multiplexing (OFDM) and/or Orthogonal Frequency Division Multiple Access (OFDMA) modulation, the embodiments of present invention are not limited thereto and, for example, can be implemented using other modulation and/or coding schemes where suitably applicable.

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, fixed user stations, mobile stations, base stations, access points (APs), hybrid coordinators (HCs), gateways, bridges, hubs, routers and other network peripherals. Further, the radio systems within the scope of the invention may include cellular radiotelephone systems, satellite systems, personal communication systems (PCS), two-way radio systems and two-way pagers as well as computing devices including such radio systems such as personal computers (PCs) and related peripherals, personal digital assistants (PDAs), personal computing accessories, hand-held communication devices and all existing and future arising systems which may be related in nature and to which the principles of the inventive embodiments could be suitably applied.

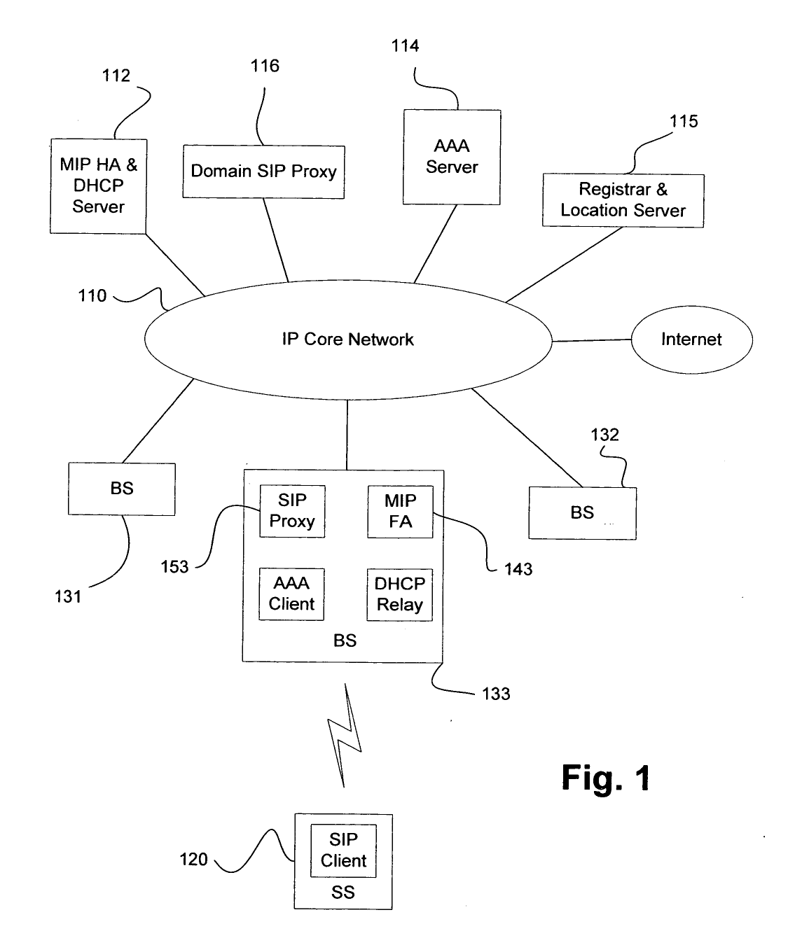

Turning to FIG. 1, a wireless communication network 100 according to various inventive embodiments may be any system capable of facilitating wireless access between, and or including, a core network 110 and one or more client stations 120. For example in one embodiment, network 100 may include a one or more base stations (BS) 131, 132, 133 which facilitate wireless communication between core network 110 and client station 120. In example implementations the wireless communication may use protocols such as those contemplated by various 802.16 standards specified by the Institute of Electrical and Electronics Engineers (IEEE) for fixed and/or mobile subscribers, although the inventive embodiments are not limited in this respect.

In the example configuration of FIG. 1, base stations 131, 132, 133 are managing entities which control the wireless communication between subscriber stations (or clients) 120 and provider network 110.

In one example implementation, base stations 131, 132, 133 are connected to a core network (e.g., an Internet Protocol network) 110, which may include one or more mobile IP home agents (HA), dynamic host configuration protocol (DHCP) and authentication, authorization and accounting (AAA) servers 112, 114 although the inventive embodiments are not limited in this respect.

When client 120 needs to execute an application that may require a certain level of QoS, a triggering mechanism may be used for base station 133 to dynamically create or adapt the wireless link between base station 133 and client 120 with the appropriate QoS requirements (e.g., bandwidth, priority, etc.). Several potential triggering mechanisms could be used and may be broadly classified into two general categories: (i) implicit and (ii) explicit triggers.

With implicit triggers, the base station 133 and/or a subscriber station 120 may monitor application IP traffic to deduce when MAC connections (with a required QoS) should be created. However, this may require the base station or subscriber station to thoroughly inspect every IP packet and/or use sophisticated logic to determine when to create and/or delete connections. This approach poses significant overhead and is not particularly suitable for subscriber station implementations. However, this approach does not require any changes to existing IP-based applications and/or their behavior.

For explicit triggers, there are essentially two ways of realizing the trigger. First, an application programming interface (API) may be developed that allows IP-based applications to explicitly request QoS connections of the wireless network. However, this approach requires applications to be designed specifically to utilize the new API and thus existing applications may not be supported. Second, a server in the network that processes application-level control messages can signal to the base station to create MAC connections with appropriate QoS on demand. This approach does not require a new API to be developed in the subscriber station and, if an existing protocol mechanism is used, may be supported by existing and emerging applications.

One such existing protocol mechanism is called Session Initiation Protocol (SIP) and has been used in multi-access wired networks where the end hosts are stationary and the SIP server is customized with specialized protocols for communication with the device implementing QoS.

SIP is an application-layer control protocol known for use in Internet telephony. SIP can be used to establish sessions for features such as audio/videoconferencing, interactive gaming and call forwarding to be deployed over IP networks. However, SIP has not heretofore been used in wireless networks to trigger the dynamic generation of MAC level connections with associated QoS between a base station (e.g., BSs 131, 132, 133) and a mobile station (e.g., client 120). Further, due to the potential for mobile station 120 to be handed off to a new base station (e.g., BS 132) by virtue of its movement in network 100, the use of SIP must be adapted to be able to seamlessly handle potential changes in the base station that is serving client 120.

According to one embodiment of the present invention, each base station 131, 132, 133 in network 100 may implement the wireless PHY and MAC and control the QoS over the air interface. For example, base station 133 may route IP packets between the radio side and the IP core network 110 and implement a mobile IP (MIP) foreign agent (FA) function 143. This is a standard architectural model of a WiMAX network although the inventive embodiments are not limited in this respect.

Network 100 may include one or more domain SIP proxies (e.g., 116) which serve as the entry/egress points of SIP signaling for a service provider's network domain. One or more SIP registrar and location servers 115 may be included to support the SIP signaling in network 100. While shown separately, it should be recognized that FIG. 1 is illustrated as a functional block diagram and respective servers could be co-located and/or combined as suitably desired. Furthermore, the term “server” is not necessarily intended to designate a free standing device as several functionalities can be implemented as “virtual servers” within a single device.

A SIP proxy (e.g., 153) may be co-located with each base station 131, 132, 133 to allow the base station to dynamically create and delete MAC connections based on application signaling and local policies for admission control. This may be performed without deeply inspecting all IP packets or implementing specialized API's in the subscriber station.

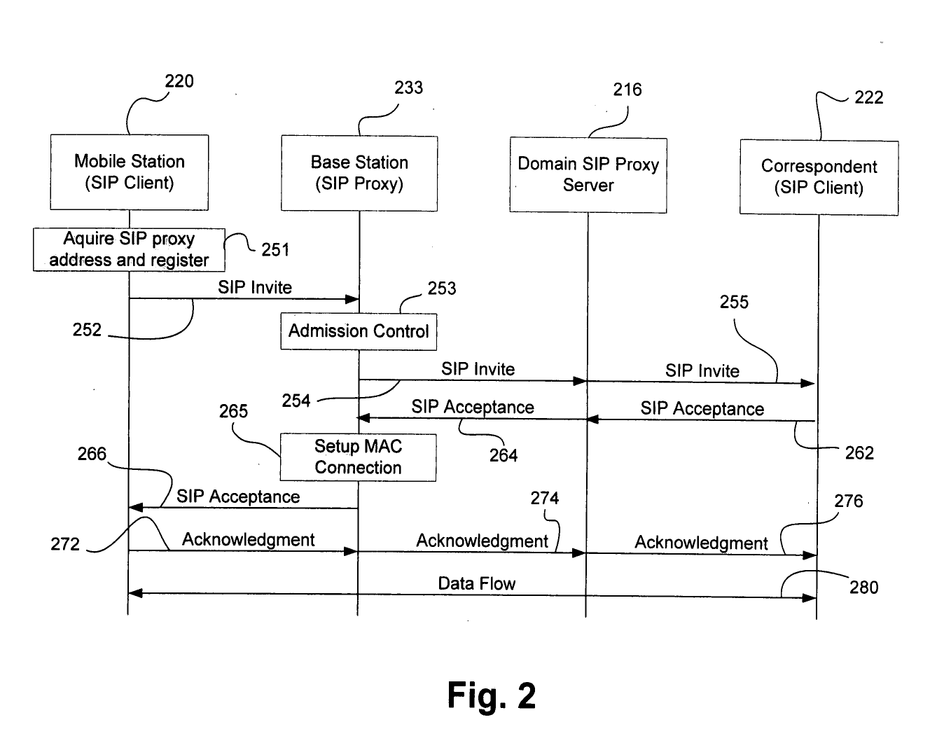

Turning to FIG. 2, a sequence diagram of a process 200 for initiating a session to dynamically build a MAC connection with required QoS parameters is shown. In this example, process 200 for message sequencing is shown between a mobile subscriber station 220 running a SIP compatible application, a serving base station 233 having an associated SIP proxy, a network domain SIP proxy server 216 and a correspondent SIP client 222 such as another mobile station or other station with which mobile subscriber station 220 needs to communicate.

Process 200 in FIG. 2 is directed to considering the initial establishment of an application flow when subscriber station 220 is attached to a given base station 233. Handover to a different base station and initiation of a service flow by a correspondent device will be discussed thereafter.

Initially, subscriber station 220 running a SIP compatible application (collectively referred to as a SIP client) needs to know an address of a server in the network to send SIP signaling messages and register 251 for the SIP messaging.

The address can be assigned in multiple ways, for instance, via manual configuration in subscriber station 220 or by using DHCP. In one embodiment, the SIP server address is a specially designated IP address (multicast or unicast) that always refers to the SIP proxy (e.g., 153; FIG. 1) in the base station that currently serves subscriber station 220. In other words, a SIP message sent to the assigned address is always received and processed by the SIP proxy in the currently serving base station. In one embodiment, this may be accomplished by setting an internal routing table in the serving base station to recognize the assigned IP address and forwarding corresponding packets to the SIP proxy (e.g., module 153 in FIG. 1), although the inventive embodiments are not limited in this respect. Thus, the SIP client in subscriber station 220 need not be aware of the mobility of the subscriber station, but can send SIP messages to an invariant proxy address.

The SIP client in subscriber station 220 may register 251 by sending a REGISTER message to base station SIP proxy 153. This message may be forwarded by the base station proxy to a centralized SIP Registrar (e.g., server 115; FIG. 1). In one embodiment, the REGISTER message may contain the home address of the subscriber station which is registered in the SIP registrar and location server.

Once registered, a session initiation may follow general SIP procedures and messaging formats per the Internet Engineering Task Force (IETF) Request For Comments (RFC) 3261 (June 2002) (www.faqs.org/rfcs/rfc3261.html), although the inventive embodiments are not limited in this manner. For example, the SIP application in the subscriber station 220 may send a SIP INVITE message 252, including call identification, From and To information, to the SIP proxy in base station 233.

The INVITE message received by the SIP proxy in the serving base station 223 may include a session descriptor which may be used to determine if there are adequate resources available to support a data flow associated with the session request and/or whether the configured policies allow the requested flow to be established. This action is shown in process 200 as Admission Control 253, and if successfully admitted, base station 223 may reserve resources which may be required for the admitted session.

In one embodiment, the SIP proxy module of base station 223 may then reformat the INVITE message to include a Record Route header with its actual IP address (i.e., the IP address of the base station) and forward it 254 to domain SIP proxy server 216. Domain SIP proxy 216 may then forward all related SIP messages to the base station proxy instead of addressing them to subscriber station 220. Thus, the SIP proxy in base station 233 may stay in the session establishment transactions, as shown in FIG. 2. The SIP proxy in base station 233, through which the session was originally established, is referred to as the “anchor” base station proxy, because all SIP messages in the current session will be routed to through this SIP proxy, by virtue of the initially assigned invariant SIP address, regardless of whether mobile station is subsequently served by another base station (e.g., via a hand off). Thus in one embodiment, SIP proxy in base station 233 stays in the control path of all session-related transactions even as subscriber station 220 moves to other base stations in the network.

Using established SIP protocols, the SIP proxy in base station 233 may send a “Trying” indication (not shown) to the subscriber station SIP client, although the inventive embodiments are not limited in this respect.

Domain SIP proxy server 216 may establish the proper local state and forward 255 the INVITE towards a correspondent SIP client 222, which may or may not occur via additional proxies (not shown). Domain SIP proxy 216 may also send a “Trying” indication (not shown) to the anchor base station SIP proxy if desired.

Correspondent client 222 may initially send a “Ringing” response (not shown) followed by an “OK” or “Accepted” message 262 when the session has been accepted. These responses may be forwarded 264 by domain proxy 216 and then forwarded 266 by base station proxy 233 to the SIP client at subscriber station 220.

According to one embodiment, once the SIP proxy in base station 233 receives the “OK” message 264 from domain SIP proxy 216, it triggers the creation and activation 265 of a MAC connection having the specified QoS parameters between base station 233 and subscriber station client 220, and for which resources were reserved during Admission Control 253.

Depending on the nature of the MAC and or wireless network protocols, setup 265 of the MAC connection might involve the allocation of air link and local buffer resources, establishment of classification rules for the ensuing data flow, and the like. The session descriptor obtained in the original invite (or any modifications to the descriptor by correspondent SIP client 222) may be used to establish the appropriate QoS parameters.

Finally, an “ACK” message is sent 272 by subscriber station SIP client 220 to base station proxy 233, which is forwarded 274, 276 to domain SIP proxy 216 and ultimately to correspondent SIP client 222.

Once the MAC connection is established 265, data may flow 280 directly between subscriber station 220 and correspondent client 222. In a preferred embodiment, the various proxies (e.g., domain SIP proxy 216 and/or the anchor SIP proxy of base station 233) are not in the data flow path. In one embodiment, Mobile IP forwarding may be used to maintain the data flow as the subscriber station moves between base stations although the inventive embodiments are not limited in this respect. However, as noted previously, SIP signaling related to this session will still be routed through the SIP proxy of anchor base station 233 regardless of what base station is currently serving mobile subscriber station 220. In this manner, a single SIP address may be used by the client in subscriber station 220 so, for all intent and purpose, the client is entirely unaware of the mobility of subscriber station 220.

At the end of the sequence discussed above, the anchor base station 233 is established as the next hop for SIP signaling flow from the domain proxy to the subscriber station SIP client (regardless of which base station is subsequently serving the subscriber station). Although the foregoing embodiments identified specific points where admission control 253 and MAC connection establishment 265 were performed, the inventive embodiments do not exclude other possibilities and or timing.

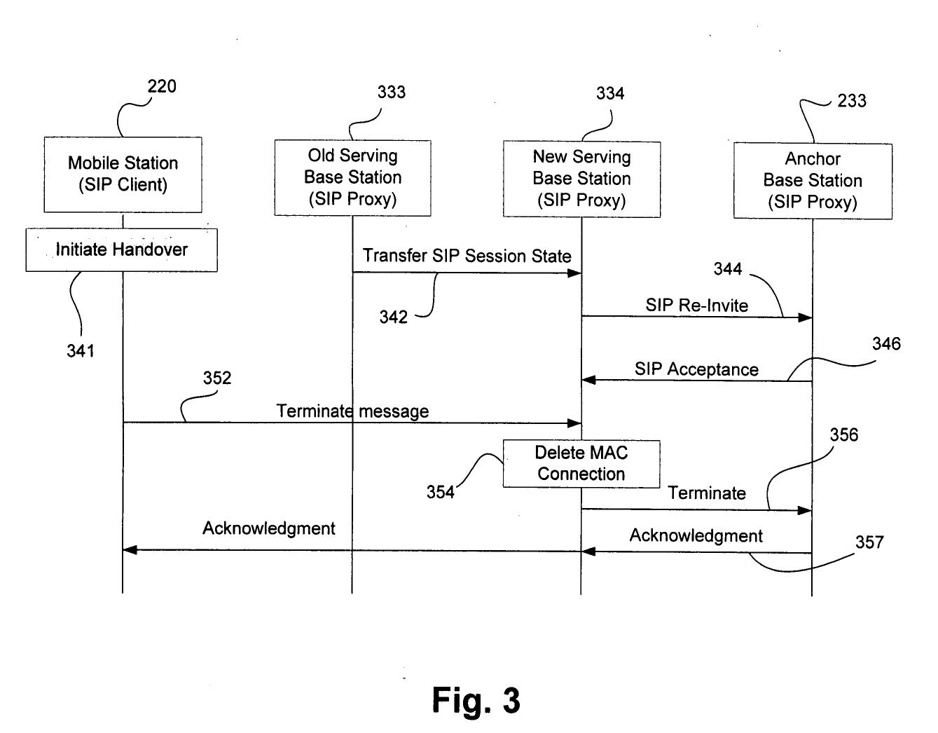

Turning to FIG. 3 a service flow process 300 is shown in the general case where subscriber station 220 has already moved to a base station 333 different from original anchor base station 233, and the SIP session established above is still active. If subscriber station 220 now has to move to a new serving base station 334 process 300 may be used for the signaling flow to maintain the SIP control path between new serving base station 334, anchor base station 233, and the domain SIP proxy (e.g., 216; FIG. 2).

A handover or handoff procedure may be performed 341 to transfer the air link connection of subscriber station 220 from old serving base station 333 to new serving base station 334. This handover procedure may be initiated by subscriber station 220 or a base station, the specific steps of which will be based on the underlying radio access technology of the network. However, typically a handover involves some interaction between old and new serving base stations 333, 334. Thus, at some point, old serving base station 333 will receive an indication of handover completion from new serving base station 334. At this point, old serving base station 333 may transfer 342 the SIP session state information to new serving base station 334. In a broadband wireless network context, for example using WiMAX protocols, the session state could also be transferred 342 with other context information related to MAC connections. In one embodiment, the session state information may include call identification, the identity of the anchor SIP proxy and/or other desired information, for example information as detailed in RFC 3261. The SIP session is then associated with the underlying MAC connection (which was handed over) to new serving base station 334.

In one embodiment, new serving base station 334 may construct and send 344 a SIP INVITE message (also referred to as a “re-INVITE” message) to the SIP proxy at anchor base station 233. The re-INVITE message may include a new record-route header which identifies new serving base station 334 as the SIP proxy now serving the subscriber station. This allows the SIP proxy in anchor base station 233 to know where to route SIP messages destined for mobile station 220.

According to one implementation, the anchor proxy in base station 233 checks the re-INVITE message. If a new proxy has been added, but no other information has changed, anchor proxy 233 may return 346 an “OK” or other acknowledgment to new serving proxy 334. This establishes the proxy at new serving base station 334 as the via for the SIP client in subscriber station 220.

The foregoing procedure 300 may therefore be completely transparent to SIP client 220, and hence no modifications are necessary to the existing client software or API. Furthermore, the above procedure is also transparent to the domain SIP proxy 216, which could therefore be an off-the-shelf implementation. Consequently, the only entities which may need modification to perform the inventive processes 200, 300 would be the base stations.

A potential variation of the previously described process is to require the SIP proxy in new serving base station 334 to send a re-INVITE message to the domain SIP proxy (e.g., 216; FIG. 2). This would establish a direct control path between domain proxy 216 and the SIP proxy in new serving base station 334. However, the logic at the domain proxy might require some modification in order to be able to terminate re-INVITE messages and/or send an OK response. Additionally, the domain proxy may need to be suitably designed to process a significant number of such re-INVITEs based on the mobility of multiple subscriber stations. Notwithstanding, both options are contemplated for the inventive embodiments, and the manner in which subscriber station mobility is handled is not limited to any particular method.

FIG. 3 also illustrates an example process for terminating an existing session. In this example, termination of the connection is initiated by the SIP client of subscriber station 220 although the inventive embodiments are not limited in this manner. In this case, subscriber station SIP client 220 may send 352 a “BYE” or “terminate” message addressed to the generic SIP proxy address (which is received by the proxy at the current serving BS). This in turn triggers the base station proxy to delete 354 the corresponding MAC connection and release any resources previously consumed by the connection. If desired, serving base station 334 may send 356 a “BYE” or “terminate” message to the domain proxy server (e.g, via anchor base station proxy 233), which may in turn forward it to the correspondent SIP client via other proxies if present.

An “ACK” message is sent 357 from the correspondent client via the domain proxy/anchor base station proxy which results in the SIP session being terminated. The associated call state may then be deleted at the various proxies and at subscriber station SIP client 220.

The above processes are directed to subscriber station-initiated SIP sessions. However, when a SIP session is to be initiated by a correspondent host and targeted at a mobile subscriber station, some mechanism is required to locate which base station is currently serving the subscriber station so that SIP messages may be passed to the subscriber station. Accordingly, in one embodiment, the SIP registration process described previously may be used for this purpose. For example, regardless of whether the SIP client in the subscriber station actually needs to initiate a SIP session, it may send a REGISTER message via the base station proxy, as described earlier. The base station proxy may forward this message to the SIP registrar and location server, after inserting its own address as the (only) contact address (as per RFC 3261) in the message.

Thus, incoming SIP session related signaling may be directed to the appropriate base station serving the mobile SIP client. The SIP client may renew SIP registrations periodically. The subscriber station, however, may move to a new base station before the next periodic registration. Accordingly, in one embodiment, the new base station may perform a registration on behalf of the subscriber station. Such a registration may be automatically triggered after each handover event. Each such registration may update any previous registration in the registrar by updating the contact information. Once an incoming SIP session is established with the mobile subscriber station via the serving base station, that base station may become the anchor base station for the control message flow related to the session. The management of the session from then on, until its termination, is similar to subscriber station-initiated SIP sessions described earlier.

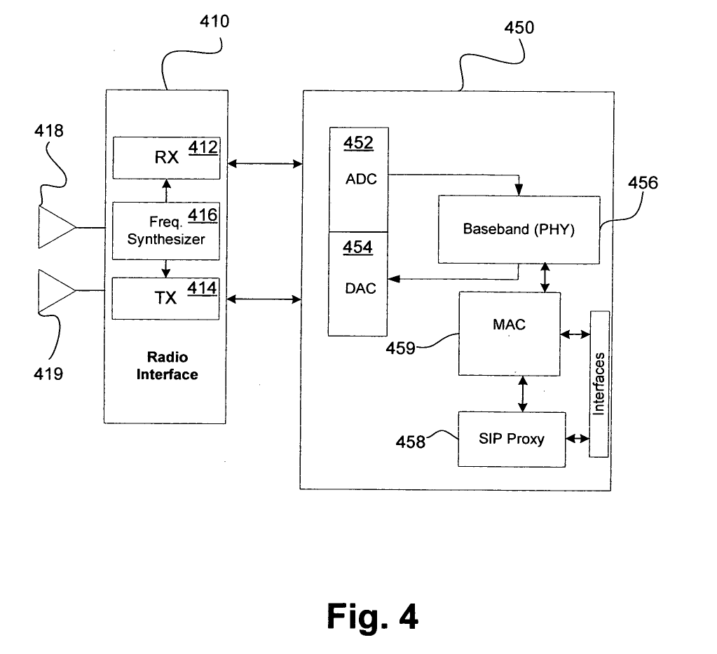

Referring to FIG. 4, a base station 400 for use in a wireless network may include a processing circuit 450 including logic (e.g., circuitry, processor and software, or combination thereof) to provide the SIP proxy as a trigger for creating MAC connections as described in one or more of the processes above. In certain embodiments, station 400 may generally include a radio frequency (RF) interface 410 coupled to processing circuit 450.

In one example embodiment, RF interface 410 may be any component or combination of components adapted to send and receive multi-carrier modulated signals (e.g., OFDM) although the inventive embodiments are not limited to any specific over-the-air interface or modulation scheme. RF interface 410 may include, for example, a receiver 412, a transmitter 414 and a frequency synthesizer 416. Interface 410 may also include bias controls, a crystal oscillator and/or one or more antennas 418, 419 if desired. Furthermore, RF interface 410 may alternatively or additionally use external voltage-controlled oscillators (VCOs), surface acoustic wave filters, intermediate frequency (IF) filters, and/or radio frequency (RF) filters as desired. Various RF interface designs and their operation are known in the art and the description thereof is therefore omitted.

In some embodiments interface 410 may be configured to be compatible with one or more of the IEEE 802.16 standards contemplated for broadband wireless networks, although the embodiments are not limited in this respect.

Processing portion 450 may communicate with RF interface 410 to process receive/transmit signals and may include, by way of example only, an analog-to-digital converter 452 for down converting received signals, a digital-to-analog converter 454 for converting digitized signals into analog signals for carrier modulation, and if desired, a baseband processor 456 for physical (PHY) link layer processing of respective receive/transmit signals. Processing portion 450 may also include or be comprised of a processing circuit 459 for medium access control (MAC)/data link layer processing.

In certain embodiments of the present invention, a processor 458 may be included for the base station SIP proxy as discussed above. Alternatively or in addition, baseband processing circuit 456 and/or MAC circuit 459 may share processing for certain of these functions or perform these processes independently. MAC, PHY and/or SIP proxy processing may also be integrated into a single circuit if desired. In other embodiments, SIP proxy 458 may be external to PHY and MAC processing circuit 450.

Apparatus 400 may be, for example, a base station, a wireless router or NIC and/or network adaptor for computing devices used for example as a wireless mesh point. Accordingly, the previously described functions and/or specific configurations of apparatus 400 could be included, arranged or omitted as suitably desired.

Embodiments of apparatus 400 may be implemented using single input single output (SISO) architectures. However, as shown in FIG. 4, certain preferred implementations may use multiple-input multiple-output (MIMO) architectures having multiple antennas (e.g., 418, 419) for transmission and/or reception.

Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of station 400 may be implemented using any combination of discrete circuitry, application specific integrated circuits (ASICs), logic gates and/or single chip architectures. Further, the features of apparatus 400 may be implemented using microcontrollers, programmable logic arrays and/or microprocessors or any combination of the foregoing where suitably appropriate (collectively or individually referred to as “logic” or “circuit”).

It should be appreciated that the example station 400 shown in the block diagram of FIG. 4 represents only one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments of the present invention.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

The invention claimed is:

1. A method for communicating in a wireless network comprising:
initiating a medium access control (MAC) quality of service (QoS) connection in a wireless link between a base station and a mobile station, wherein initiating of the MAC QoS connection is triggered by session initiation protocol (SIP) signaling received at the base station.

2. The method of claim 1 wherein the MAC QoS connection includes a QoS level requested by an application on the mobile station.

3. The method of claim 1 wherein the base station includes a SIP proxy and wherein the mobile station uses a single invariant Internet Protocol (IP) address for SIP messaging corresponding to the initiated connection regardless of whether the mobile station subsequently moves to a different base station.

4. The method of claim 3 further comprising registering an Internet Protocol (IP) address of the SIP proxy at the base station with a registrar to facilitate correspondent-initiated SIP communications between the mobile station and a correspondent device.

5. The method of claim 1 further comprising transferring a SIP session state to a second base station to which the mobile station is handed over.

6. The method of claim 4 further comprising updating the SIP proxy in the base station with an IP address of a second SIP proxy of a second base station to which the mobile station is handed over.

7. An apparatus comprising:
a processing circuit to utilize session initiation protocol (SIP) signaling to trigger dynamic creation of a medium access control (MAC) quality of service (QoS) connection in a wireless link between a base station and a mobile station.

8. The apparatus of claim 7 wherein the circuit comprises a SIP proxy and wherein a QoS level of the MAC QoS connection is based on SIP signaling from an application on the mobile station.

9. The apparatus of claim 8 wherein once the MAC QoS connection is established, the SIP proxy remains in a SIP control signaling path regardless of whether the MAC QoS connection is handed over to a different base station.

10. The apparatus of claim 7 wherein the base station and mobile station communicate over the wireless link using orthogonal frequency division modulation (OFDM) protocols.

11. The apparatus of claim 7 wherein the apparatus comprises the base station and is part of a wireless broadband network.

12. The apparatus of claim 7 wherein the processing circuit is configured to transfer a SIP session state to a new serving base station upon handoff of the mobile station to the new serving base station.

13. A method for communicating in a wireless network, the method comprising:
receiving a session initiation protocol (SIP) invite message from a mobile station over a wireless link;
updating the SIP invite message to include an Internet Protocol (IP) address of a device receiving the SIP invite message;
forwarding the updated SIP invite message to a domain SIP proxy server; and
establishing a medium access connection (MAC) quality of service (QoS) connection over the wireless link having a QoS level specified in the received SIP invite message.

14. The method of claim 13 wherein establishing the MAC QoS connection is performed in response to receiving a SIP acceptance message from the domain SIP proxy server.

15. The method of claim 13 further comprising transferring a SIP session state to a new serving base station if the mobile station is handed over to the new serving base station.

16. The method of claim 13 further comprising terminating the MAC QoS connection in response to receiving a terminate message from the mobile station.

17. A system for wireless communications, the system comprising:
a processing circuit to dynamically establish a medium access control (MAC) quality of service (QoS) connection in a wireless link between the system and a mobile station, the dynamic establishment of the MAC QoS connection being triggered by session initiation protocol (SIP) signaling; and
a radio interface circuit coupled to the processing circuit, the radio interface including at least two antennas to transmit the data in the form of radio signals.

18. The system of claim 17 wherein the MAC QoS connection is established in response to SIP signaling received from at least one of the mobile station or a domain SIP proxy server.

19. The system of claim 17 wherein the processing circuit includes a SIP proxy to processing the SIP signaling.

20. The system of claim 19 wherein the SIP proxy is adapted to update a SIP invite message received from the mobile station to include an Internet Protocol (IP) address of the system.

21. The system of claim 17 wherein the system comprises a base station in a wireless broadband network.

22. An article of manufacture comprising a tangible medium having machine readable instructions stored thereon, the machine readable instructions when executed by a processing platform results in:
initiating a medium access control (MAC) quality of service (QoS) connection in a wireless link between a base station and a mobile station, wherein initiating of the MAC QoS connection is triggered by session initiation protocol (SIP) signaling.

23. The article of claim 22 further including machine readable instructions, when executed, results in:
sending a SIP registration message to a registrar to facilitate correspondent-initiated SIP sessions between a correspondent device and the mobile station.

24. The article of claim 22 further including machine readable instruction, when executed, results in:
a SIP proxy being integrated with the base station.
